(19) United States
(12) Patent Application Publication
(10) Pub. No.: US 2005/0261101 A1
(43) Pub. Date: Nov. 24, 2005

(54) Torque coupling differential assembly with torque disconnect

(76) Inventor: Jun Yoshioka, Waterville, OH (US)

Correspondence Address: BERENATO, WHITE & STAVISH, LLC, 6550 ROCK SPRING DRIVE, SUITE 240, BETHESDA, MD, 20817, US

(21) Appl. No.: 10/851,231

(22) Filed: May 24, 2004

(51) Int. Cl. F16H 48/20

(52) U.S. Cl. 475/231

(57) ABSTRACT

A torque coupling differential assembly is provided for use in auxiliary axle of an all-wheel drive vehicle. The torque coupling differential assembly comprises a first casing defining an input member, a differential mechanism, a torque coupling device with a clutch assembly provided to transmit a drive torque from the first casing to the differential mechanism and a disconnecting mechanism selectively shiftable between a disconnected position when the differential mechanism is disconnected from the torque coupling device and a connected position when the differential mechanism is drivingly engaged to the torque coupling device so that the clutch assembly transmits torque from the first casing to the differential mechanism when the torque coupling device is in an activated position and the disconnecting mechanism is in the connected position. Both the torque coupling device and the differential mechanism are disposed within the housing.

### BACKGROUND OF THE INVENTION

1. Field of the Invention

The present invention relates to torque transmitting systems in general and, more particularly, to a torque coupling differential assembly provided with a disconnecting mechanism.

2. Description of the Prior Art

Torque applied to a tire through a drive shaft propels a vehicle by the friction between the tire and the surface of the road for the vehicle. Occasionally, slip takes place between the road surface and the tire. The ratio of the slip depends on the coefficient of friction between the tire and the road surface. The coefficient of friction fluctuates due to the states of the road surface and the tire, the normal load upon the tire, the magnitude of the torque transmitted to the tire, the driving speed of the vehicle, and so forth.

When the torque transmitted to the tire is so high that the tire slips, the torque does not fully act to propel the vehicle, resulting in wasted motive power, lowered fuel efficiency, and adverse vehicle handling. When the fluctuation in the coefficient of friction is large or the coefficient of friction is very small, as on a muddy road, a partially icy road, a snowy road, a graveled road, or the like, the stability of movement of the vehicle is reduced and the stopping distance increases in the case of locking of the wheel in braking. Moreover, it is sometimes difficult to maintain the direction of movement of the vehicle in the case of locking of the rear wheel (in particular, in braking). For the above-mentioned reasons, four-wheel-drive vehicles have become popular vehicles for driving on a wide range of road conditions. In four-wheel-drive vehicles, the driving power of an engine is dividedly transmitted to four wheels to eliminate the above-mentioned drawbacks and problems.

Since a rotation speed difference arises between the front and rear wheels of the four-wheel-drive vehicle due to the turning radius difference between the front and the rear wheels at the time of turning of the vehicle, torsional torque is caused (a tight corner braking phenomenon) between the drive shafts for the front and the rear wheels if the turning is performed on a high-friction-coefficient road (such as a paved road), on which the driving wheel and the surface of the road are less likely to slip relative to each other. For that reason, different types of four-wheel-drive vehicles have been developed in order to prevent the deterioration of the moving property of each vehicle due to the torsional torque, the increase in the wear of the tire, the shortening of the life of the vehicle, and so forth.

One of the different types of four-wheel-drive vehicles is a part time four-wheel-drive vehicle in which the driver shifts from the four-wheel drive mode to the two-wheel drive mode when running on a high-friction-coefficient road such as a paved road. Another type of four-wheel-drive vehicle is a full time-four-wheel-drive or all-wheel-drive vehicle equipped with a center differential unit for dividedly transmitting motive power to a front and a rear wheel drive shafts. Another type of four-wheel-drive vehicle is a full time-four-wheel-drive vehicle in which the front or rear wheels are always driven and in which the rear or front wheels are driven through a viscous clutch which transmits torque by the viscosity of silicone oil or the like. Although the part time-four-wheel-drive vehicle can be manufactured at a relatively low cost, it is troublesome to shift between the two-wheel drive and the four-wheel drive and it is likely that the vehicle is slowly turned when the driver mistakenly fails to properly choose between four-wheel drive and two-wheel drive. It is less likely that every driver can precisely predict the occurrence of slip of the driving wheel and take appropriate action.

Full time-four-wheel-drive vehicle, that are equipped with the center differential unit, have a front wheel drive differential unit, which dividedly transmits motive power to the right and left front wheels, and a rear wheel drive differential unit, which dividedly transmits motive power to the right and left rear wheels. These full-time four-wheel-drive vehicles suffer from a problem that no motive power is transmitted to any of the remaining three of four driving wheels when one wheel is caused to spin or loses the tire grip due to overhanging on the road side or ditch, a slip on an icy road, or the like. For that reason, the center differential unit is provided with a differential locking mechanism. The differential locking mechanism is of the mechanical type or the electronic control type. In the mechanical type, a differential rotation which takes place in the center differential unit is stopped through manual shifting when no motive power is transmitted to the three of the four driving wheels in order to put the vehicle into the state of direct-connection four-wheel drive. In the electronic control type, the speed of the vehicle, the angle of turning of the vehicle, the racing of the drive shaft, and so forth are detected by sensors in order to put the differential locking mechanism into a locking or unlocking state through an electronic controller. As for the mechanical type, it is difficult to set a differential locking start time point, the time point cannot be changed depending on the moving condition of the vehicle, and it is more difficult to automate the differential locking mechanism. As for the electronic control type, a device for controlling the differential locking mechanism is more complex and the cost of production of the mechanism is very high.

Since the center differential unit comprises an input shaft which receives motive power transmitted from an engine through a transmission, a differential case connected to the input shaft, a pinion shaft which is driven by the differential case, pinions rotatably attached to the peripheral surface of the pinion shaft, a first side gear which is engaged with the pinion and connected to a first differential means for driving the front or rear wheels, a second side gear which is engaged with the pinion and connected to a second differential means for driving the rear or front wheels, and the differential locking mechanism which engages the differential case and the side gear with each other through mechanical operation or electronic control, the cost of production of the center differential unit is very high and the weight of the vehicle is increased.

It is also known to replace the aforementioned center differential with a torque transmission coupling that includes an input shaft drivingly connected to the transmission and a first differential, an output shaft drivingly connected to a second differential, an oil pump driven by the relative rotation between the input and the output shafts to generate oil pressure corresponding to the speed of the relative rotation, and a friction clutch mechanism engaging the input shaft and the output shaft with each other by the oil pressure generated by the oil pump. The torque transmitted by the torque coupling is proportional to the speed of the relative rotation. When the rotation speed of the wheels driven by the first differential is higher than that of the wheels driven by the second differential, a rotation speed difference takes place between the input and the output shafts. The oil pump generates the oil pressure corresponding to that rotation speed difference. The oil pressure is applied to the friction clutch mechanism so that torque is transmitted from the input shaft to the output shaft depending on the magnitude of the oil pressure. When torque is transmitted to the second differential, the rotation speed of the wheels drivingly connected to the second differential is raised to approach that of the wheels driven by the first differential, thereby reducing the rotation speed difference between the input and the output shafts. In short, the torque transmission coupling operates in response to the rotation speed difference that takes place depending on the environmental situation of the vehicle and the moving conditions thereof. In other words, a prescribed slip is always allowed.

The conventional torque coupling assemblies, however, suffer from drawbacks inherent in their assembly and location within the vehicle drivetrain. Conventional torque coupling assemblies are installed in the transfer case or in-line with the driveline or driveshaft. The need therefore exists for a torque coupling assembly that eliminates the need for a center differential in the transfer case, i.e. an inter-axle differential, thereby reducing the driveline complexity and cost without requiring a separate torque coupling in the transfer case or in-line with the driveline.

### SUMMARY OF THE INVENTION

The present invention provides a torque coupling differential assembly for use in an auxiliary drive axle assembly of an all-wheel-drive (AWD) motor vehicle having a primary full-time drive axle assembly driven by a prime mover and an auxiliary drive axle assembly.

The torque coupling differential assembly of the present invention is provided between said primary and auxiliary drive axle assemblies and comprises a first casing defining an input member, a differential mechanism, a speed-sensitive torque coupling device with a clutch assembly provided to transmit a drive torque from the first casing to the differential mechanism and a disconnecting mechanism selectively shiftable between a disconnected position when the differential mechanism is disconnected from the speed-sensitive torque coupling device and a connected position when the differential mechanism is drivingly engaged to the speed-sensitive torque coupling device so that the clutch assembly transmits torque from the first casing to the differential mechanism when the speed-sensitive torque coupling device is in an activated position and the disconnecting mechanism is in the connected position. Both the speed-sensitive torque coupling device and the differential mechanism are disposed within the housing.

Preferably, the speed-sensitive torque coupling device includes a friction clutch assembly including a first set of clutch plates secured to the first casing, a clutch sleeve and a second set of clutch plates secured to the clutch sleeve, and a speed sensitive fluid pump assembly actuated in responsive to a relative rotation between the first casing and the clutch sleeve to thereby actuate the friction clutch assembly.

The torque coupling in accordance with second exemplary embodiment of the present invention allows variable torque distribution between the primary drive axle assembly and the auxiliary drive axle assembly, as well as the speed differential between the left and right wheels of the auxiliary drive axle assembly of the AWD motor vehicle and, at the same time, eliminating any parasitic losses due to parasitic clutch friction.

### BRIEF DESCRIPTION OF THE DRAWINGS

Other objects and advantages of the invention will become apparent from a study of the following specification when viewed in light of the accompanying drawings, wherein:

FIG. 1 is a schematic view of an all-wheel-drive vehicle incorporating a torque coupling differential assembly of the present invention;

FIG. 2 is a is a sectional view of the torque coupling differential assembly in accordance with preferred embodiment of the present invention;

FIGS. 3-7 are exploded views of the primary components of the torque coupling differential assembly in accordance with preferred embodiment of the present invention.

### DETAILED DESCRIPTION OF PREFERRED EMBODIMENTS

The preferred embodiment of the present invention will now be described with the reference to accompanying drawings.

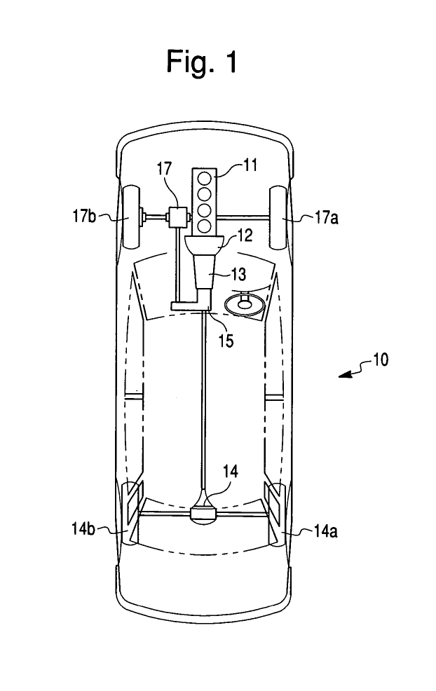

FIG. 1 schematically depicts an all-wheel-drive (AWD) motor vehicle 10 provided in accordance with the present invention that comprises a prime mover, such as an engine 11, a transmission 13 which is driven through a clutch 12 by the engine 11 to change the speed of an output rotation of the engine 11. A transfer case 15 divides torque transmission between a first, primary full-time drive axle assembly that drives one of front wheels 17a, 17b and rear wheels 14a, 14b, and a second, auxiliary drive axle assembly selectively actuated to drive the other of the front wheels 17a, 17b and the rear wheels 14a, 14b. Preferably, as illustrated in FIG. 1, the primary drive axle assembly is a rear axle 14, while the auxiliary drive axle assembly is a front axle 17. It will be appreciated that alternatively, the front axle 17 may be arranged as the primary drive axle assembly, and the rear axle 14 as the auxiliary drive axle assembly.

The auxiliary drive axle assembly 17 of the preferred embodiment of the present invention includes a torque coupling differential assembly 20. The torque coupling differential assembly 20 comprises an oil pump that is driven by the relative rotation between a ring gear and a differential mechanism (planetary gear set sub-assembly) to generate oil pressure corresponding to the speed of the relative rotation. A friction clutch assembly engages the ring gear and the differential mechanism with each other by the oil pressure generated by the oil pump. The torque transmission coupling assembly has such a property that the torque transmitted thereby is proportional to the speed of the relative rotation.

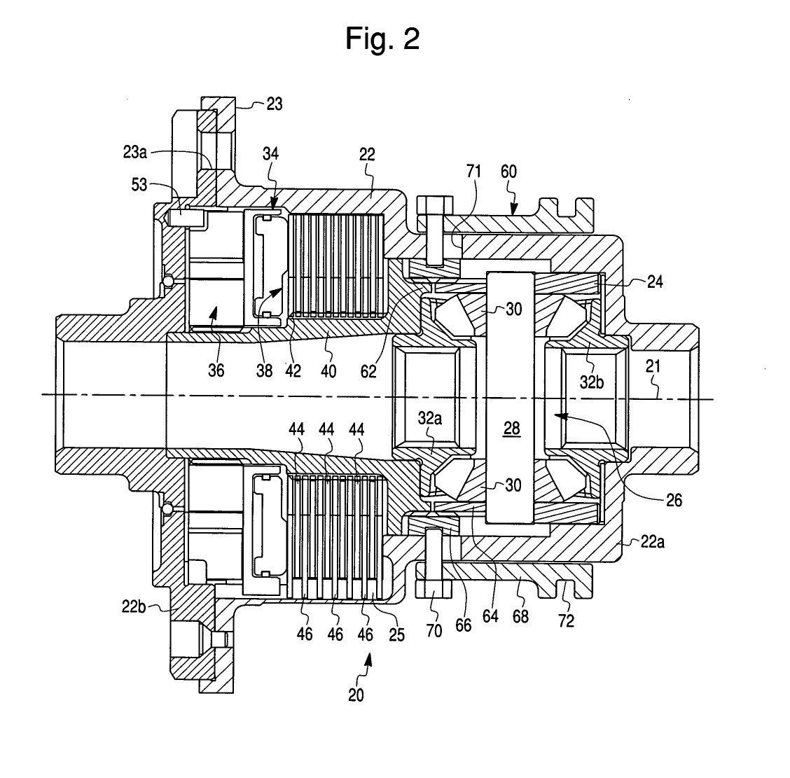

With reference to FIG. 2, the torque coupling differential assembly 20 comprises a housing having a first (or outer) casing 22 defining an input member and a second (or inner) casing 24. A flange 23 is formed on the first casing 22. Apertures 23a are provided to receive fasteners to mount a ring gear (not shown) to the first casing 22. It will be understood that various fastening assemblies may be employed without departing from the objectives of this invention. As illustrated in FIG. 2, the outer casing 22 includes a casing member 22a and a cover member 22b secured to each other by any appropriate fashion known in the art.

Both the first and second casings 22 and 24 are rotatable about an axis 21. As illustrated, the second housing is rotatably mounted within the first casing 22 substantially coaxially thereto for rotation about the axis 21 relative to the first casing 22.

The torque coupling differential assembly 20 further comprises a differential mechanism 26 disposed within the second casing 24. The differential mechanism 26 includes a pinion shaft 28 driven by the second casing 24, pinions 30 rotatably mounted to the pinion shaft 28, and side gears 32a, 32b engaged with the pinions 30. The side gears 32a, 32b drive the right and left axle shafts (not shown in FIG. 2) of the auxiliary axle assembly 17.

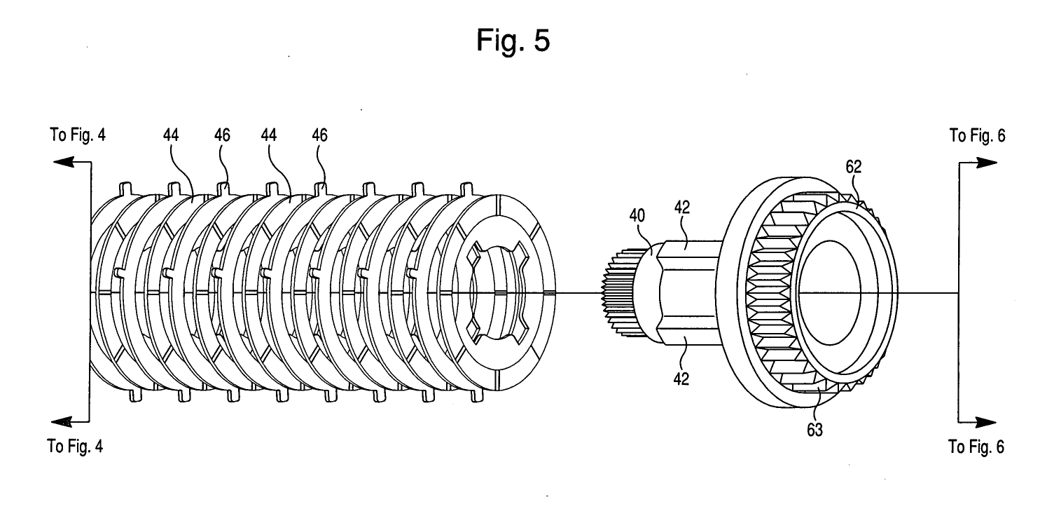

As further illustrated in FIG. 2, the torque coupling differential assembly 20 also comprises a speed-sensitive torque coupling device, shown generally as assembly 34. The speed-sensitive torque coupling device 34 included in the preferred embodiment of the present invention comprises a clutch sleeve 40, a speed sensitive fluid pump 36 and a friction clutch assembly 38. The clutch sleeve 40, illustrated in detail in FIG. 5, is rotatably mounted within the first casing 22 substantially coaxially thereto for rotation about the axis 21 relative to both the first casing 22 and the second casing 24. The fluid pump 36 shown and described herein is a gerotor pump of the automatically reversible unidirectional flow type. However, it is to be understood that any appropriate fluid pump known to those skilled in the art will be within the scope of the present invention. The specific structure of the fluid pump 36 and friction clutch assembly 38 will be described below.

The friction clutch assembly 38 is disposed adjacent the side gear 32a and includes a friction clutch pack disposed between the outer casing 22 and the clutch sleeve 40. Forming the clutch pack are clutch plates 44 and 46 alternately mounted between the clutch sleeve 40 and the outer casing 22. The inner clutch plates 44 mate with splines 42 formed on the clutch sleeve 40, and the outer clutch plates 46 mates with splines 25 formed on an inner surface of the outer casing 22. The inner clutch plates 44 frictionally engage the outer clutch plates 46 to form a torque coupling arrangement between the outer casing 22 and the clutch sleeve 40. Torque is transferred from the ring gear to the outer casing 22, then to the clutch plates 46. The clutch plates 46 transmit torque to the clutch plates 44 which, in turn, transmit torque to the clutch sleeve 40.

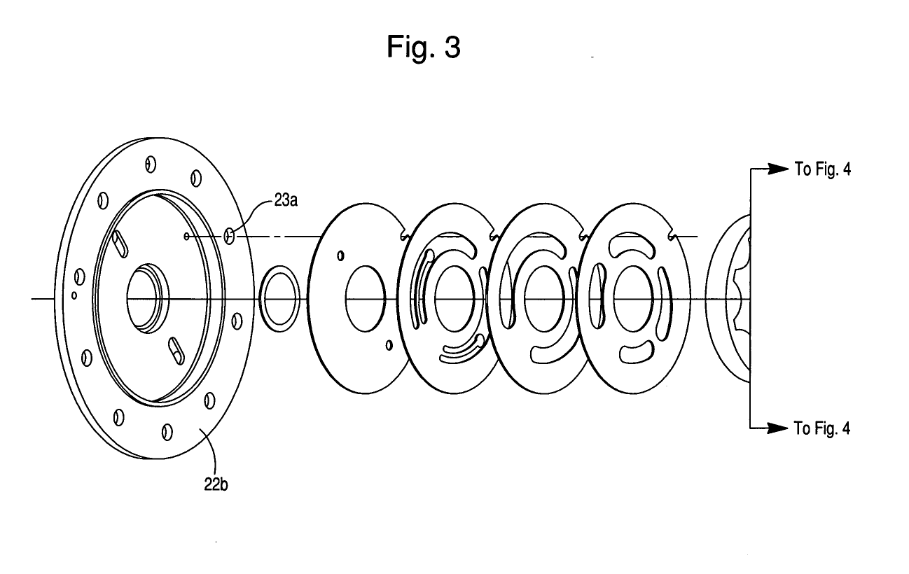

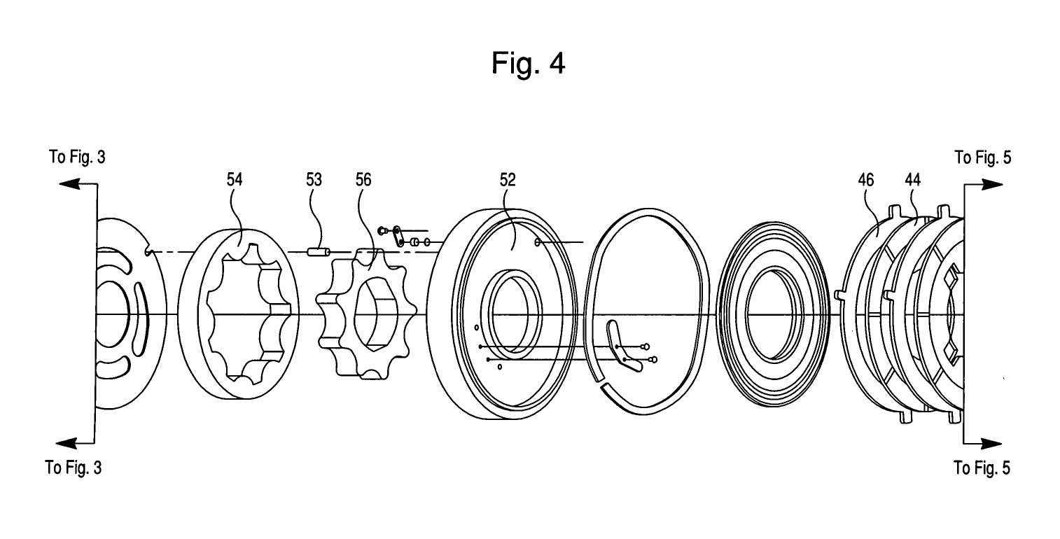

As illustrated in FIGS. 3-4, the speed sensitive fluid pump 36 actuates the friction clutch assembly 38 to increase the frictional engagement between the clutch plates 44 and 46. The speed sensitive fluid pump 36 comprises an outer ring member 52, an outer rotor 54 and an inner rotor 56. The inner rotor 56 mates with the clutch sleeve 40, and the outer ring member 52 mates with the outer casing 22 via pin 53.

As further illustrated in FIG. 4, the inner rotor 56 has one less tooth than the outer rotor 54 and when the inner rotor 56 is driven it will drive the outer rotor 54, which can freely rotate within the outer ring member 52, thus providing a series of decreasing and increasing volume fluid pockets by means of which fluid pressure is created. The inner rotor 56 is matingly connected to the clutch sleeve 40, and the sleeve 40 meshes with clutch plates 44. When relative motion takes place between the outer casing 22 and the clutch sleeve 40, the clutch sleeve 40 will rotate the inner rotor 56 of the fluid pump 36 to create fluid pressure.

As further illustrated in FIG. 2, the torque coupling differential assembly 20 also comprises a disconnecting mechanism 60 selectively shiftable between a disconnected position when the second casing 24 is disconnected from the speed-sensitive torque coupling device 34 and a connected position (shown in FIG. 2) when the second casing 24 is drivingly engaged to the speed-sensitive torque coupling device 34 so that the friction clutch assembly 38 transmits torque from the first casing 22 to the second casing 24 when the friction clutch assembly 38 is in an engaged position and the disconnecting mechanism 60 is in the connected position.

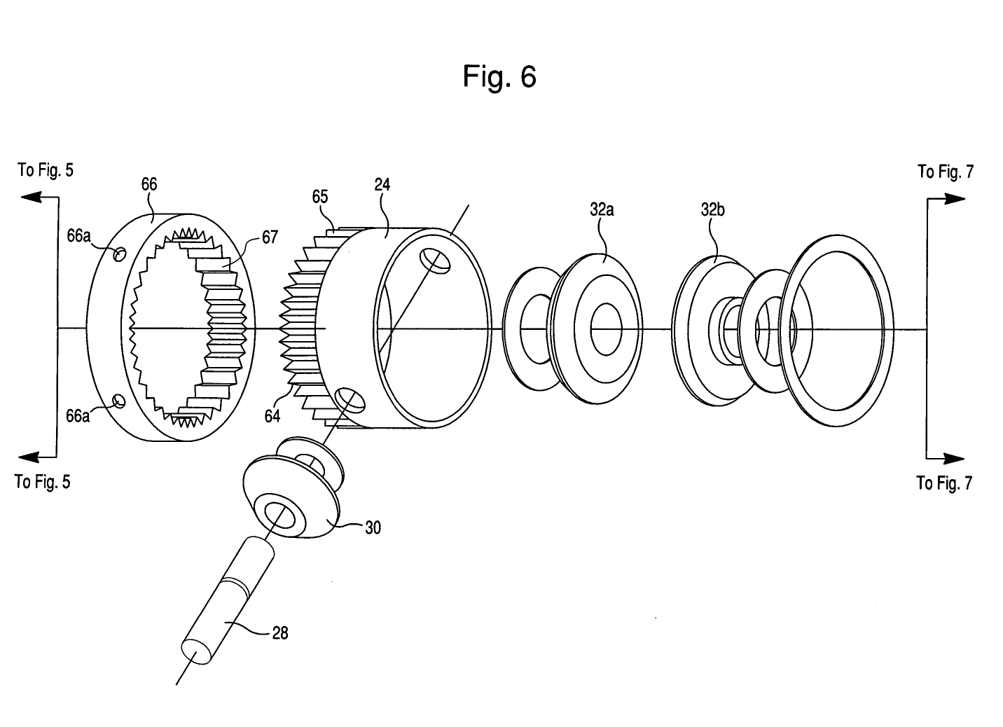

More specifically, the disconnecting mechanism 60 in accordance with the preferred embodiment of the present invention is in the form of a dog clutch and comprises an input part 62, an output part 64 and a connecting part 66 axially slideable between the disconnected position and the connected position. All the parts 62, 64 and 66 are substantially cylindrical and coaxial to each other. Preferably, the input part 62 is formed integrally with the clutch sleeve 40 and is provided with splines 63 at an outer peripheral surface thereof, as shown in FIG. 5. Similarly, the output part 64 is formed integrally with the inner casing 24 and is provided with splines 65 at an outer peripheral surface thereof, as shown in FIG. 6. In turn, the connecting part 66 has internal splines 67, shown in FIG. 6, adapted to selectively engage with the splines 63 and 65 of the input and output parts 62 and 64, respectively, in accordance with the axial position of the connecting part 66. In particular, in the connected position (shown in FIG. 2), the splines 67 of the connecting part 66 engage splines 63 and 65 of both the input and output parts 62 and 64. In the disconnected position, the connecting part 66 is shifted in the rightward direction to disengage the splines 67 of the connecting part 66 from the splines 63 of the input part 62.

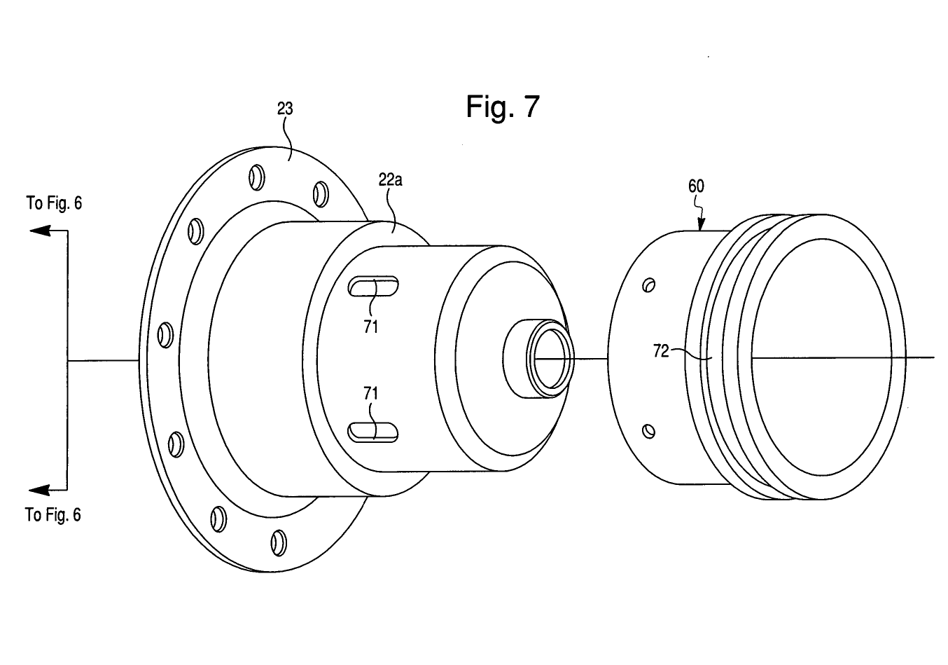

The disconnecting mechanism 60 further includes a shifting collar 68 positively coupled to the connecting part 66 through couplings pins 70 engaging recesses 66a formed in the connecting part 66. As shown in FIGS. 2 and 7, the outer casing is provided with axially elongated openings 71 provided to receive the engaging pins 70 therethrough and to allow axial movement of the engaging pins 70 in order to move the connecting part 66 between the disconnected and connected positions thereof. The shifting collar 68 is slidably supported by an outer peripheral surface of the outer casing 22.

As depicted in FIGS. 2 and 7, the shifting collar 68 is formed with an outer circumferential groove 72 provided to receive a fork member of an actuator (not shown) for operating the disconnecting mechanism 60. It will be appreciated that the actuator of the disconnecting mechanism 60 may be of any appropriate type known in the art, such as vacuum, pneumatic, hydraulic, electrical, electromechanical or motor type, etc. actuatable manually or automatically according to the presence or possibility of a difference in speed between the primary and auxiliary axle assemblies.

Preferably, as disclosed above, the torque coupling differential assembly 20 of FIGS. 2-7 is provided within the auxiliary front axle assembly 17. Therefore, when the rotation speed of the rear wheels 14a, 14b driven by the primary drive axle assembly 14 is higher than that of the front wheels 17a, 17b driven by the auxiliary drive axle 17, a rotation speed difference takes place. In that case, the fluid pump 36 generates the oil pressure corresponding to that rotation speed difference. The oil pressure is applied to the friction clutch assembly 38 compresses the clutch plates 44 and 46 to activate the friction clutch assembly 38. At the same time, the disconnecting mechanism 60 is shifted to the connected position. In this case the drive torque from the engine 11 and the transmission 13 is transmitted from the outer casing 22 to the clutch sleeve 40 through the activated friction clutch assembly 38, then from the clutch sleeve 40 to the inner casing 24 through the disconnecting mechanism 60. Therefore, the drive torque is properly distributed between the first drive axle assembly 14 and the second drive axle assembly 17 depending on the magnitude of the oil pressure. When the torque is transmitted to the drive axle assembly 17, the rotation speed of the wheels 17a, 17b drivingly connected to the torque coupling differential assembly 20 of the drive axle assembly 17 is raised to approach that of the wheels 14a, 14b driven by the primary drive axle assembly 14, thereby reducing the rotation speed difference between the front and rear wheels of the motor vehicle 10.

When for some reason determined by an electronic control unit (not shown) of the motor vehicle or by an operator, it is necessary to disconnect the auxiliary drive axle 17, the disconnecting mechanism 60 is shifted to the disconnected position. In that case, no rotation speed difference takes place between the outer casing 22 and the clutch sleeve 40, and the fluid pump 36 does not generate the oil, thus no oil pressure is applied to the friction clutch assembly 38 and the friction clutch assembly 38 is deactivated. Moreover, as the clutch sleeve 40 is disconnected from the inner casing 24, the inner and outer clutch plates 44 and 46 of the friction clutch assembly 38 remain substantially stationary relative to one another, thus eliminating any parasitic losses due to parasitic clutch friction caused by the speed difference between the inner and outer clutch plates 44 and 46.

In the low speed running condition of the vehicle 10, the absolute value of the speed of rotation transmitted to the auxiliary drive axle assembly 17 is small, and the rotation speed of the outer casing 22 is therefore small as well. Even if the speed of the rotation of the inner casing 24 is zero or very low, the absolute value of the rotation speed difference between the outer casing 22 and the inner casing 24 is small. In addition, the rising of the oil pressure generated by the fluid pump 36 at the low rotation speed is generally slow due to the internal leak of the pump 36. For these reasons, the torque transmitted through the friction clutch assembly 38 is very low, so that the outer casing 22 and the inner casing 24 are allowed to slip relative to each other. In such a situation, the disconnecting mechanism 60 is shifted to the disconnected position so that the inner and outer clutch plates 44 and 46 of the friction clutch assembly 38 remain substantially stationary relative to one another. Thus, any parasitic losses in the friction clutch assembly 38 due to parasitic clutch friction caused by the speed difference between the inner and outer clutch plates 44 and 46 is eliminated.

In the high speed running of the vehicle, if the disconnecting mechanism 60 is in the connected position and the rotation speed of the wheels driven by the auxiliary drive axle assembly 17 is even slightly lower than that of the wheels driven by the primary drive axle assembly 14, the absolute value of the rotation speed difference between the outer casing 22 and the and the inner casing 24 is certain to increase, because the absolute value of the speed of rotation transmitted to the primary drive axle assembly 14 is large in proportion to the driving speed of the vehicle 10. Therefore, the torque transmitted through the friction clutch assembly 38 is also high, corresponding to the absolute value of the rotation speed difference between the outer casing 22 and the and the inner casing 24 so that these casings are maintained in a torque transmission state approximate to a directly connected state. For that reason, in the rapid running of the vehicle, the torque of the engine 11 is transmitted to the front and the rear wheels, while the torque is divided nearly at a ratio of 50:50 between them, so that the stability of the running of the vehicle and the fuel efficiency thereof are enhanced.

Furthermore, when the disconnecting mechanism 60 is in the connected position and some driving wheel slips during the running of the vehicle provided in accordance with the present invention, the rotation speed difference between the outer casing 22 and the and the inner casing 24 of the torque coupling differential assembly 20 increases immediately so that the oil pressure corresponding to the rotation speed difference increases. Consequently, the friction clutch assembly 38 immediately acts to prevent the increase in the rotation speed difference between the outer casing 22 and the and the inner casing 24 to keep the slipping driving wheel from skidding sideways. Excess torque is transmitted to the other non-slipping driving wheels instead of the slipping driving wheel, so that the torque of the engine transmitted through the transmission is dividedly transmitted to the primary and auxiliary drive axle assemblies 14 and 17. Appropriate driving forces are thus automatically and constantly applied to the front and the rear driving wheels with good response.

When the front wheels 17a, 17b of the all-wheel-drive vehicle provided in accordance with the present invention is driven by the auxiliary drive axle assembly 17, torque is transmitted to the rear wheels 14a, 14b at the side of the primary drive axle assembly 14 as long as the front wheels 17a, 17b are not locked at the sharp braking of the vehicle. For that reason, an anti-locking effect is produced. In other words, the torque is transmitted to the rear wheels 14a, 14b from the front wheels 17a, 17b through the torque coupling differential assembly 20. This serves to prevent the early locking of the rear wheels, which would be likely to occur at the time of braking on a low-friction-coefficient road such as an icy road.

Thus, the differential assembly in accordance with the present invention is a speed-sensitive, on-demand torque coupling differential assembly that allows variable torque distribution between the primary drive axle assembly and the auxiliary drive axle assembly, as well as the speed differential between the left and right wheels of the auxiliary drive axle assembly of the AWD motor vehicle and, at the same time, eliminating any parasitic losses due to parasitic clutch friction.

The foregoing description of the preferred embodiment of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the present invention be defined by the claims appended thereto.

1. A torque coupling differential assembly comprising:
a housing defining an input member;
a differential mechanism;
a torque coupling device including a clutch assembly and provided to transmit a drive torque from said housing to said differential mechanism; and
a disconnecting mechanism selectively shiftable between a disconnected position wherein said differential mechanism is disconnected from said torque coupling device and a connected position wherein said differential mechanism is drivingly engaged to said torque coupling device so that said clutch assembly transmits torque from said input member to said differential mechanism when said torque coupling device is activated;
wherein both said torque coupling device and said differential mechanism are disposed within said housing.

2. The torque coupling differential assembly as defined in claim 1, wherein said housing includes a first casing defining said input member and a second casing driving said differential mechanism.

3. The torque coupling differential assembly as defined in claim 2, wherein said clutch assembly of said torque coupling device is a friction clutch assembly, and wherein said torque coupling device includes:
said friction clutch assembly including a first set of clutch plates secured to said first casing, a clutch sleeve and a second set of clutch plates secured to said clutch sleeve; and
a speed sensitive fluid pump assembly actuated in responsive to a relative rotation between said first casing and said clutch sleeve to thereby actuate said friction clutch assembly.

4. The torque coupling differential assembly as defined in claim 3, wherein said second casing is disconnected from said friction clutch assembly in said disconnected position of said disconnecting mechanism, and wherein said second casing is drivingly engaged to said friction clutch assembly in said connected position of said disconnecting mechanism so that said friction clutch assembly transmits torque from said first casing to said second casing when said friction clutch assembly is in an engaged position and said disconnecting mechanism is in said connected position.

5. The torque coupling differential assembly as defined in claim 4, wherein said second casing is disconnected from said clutch sleeve of said friction clutch assembly in said disconnected position of said disconnecting mechanism, and wherein said second casing is drivingly engaged to said clutch sleeve of said friction clutch assembly in said connected position of said disconnecting mechanism.

6. The torque coupling differential assembly as defined in claim 5, wherein said disconnecting mechanism includes a connecting part selectively moveable between a connected position wherein said connecting part positively is positively engaged with both said second casing and said clutch sleeve to prevent relative rotation therebetween and a disconnected position wherein said connecting part is disengaged with one of said second casing and said clutch sleeve to allow relative rotation therebetween.

7. The torque coupling differential assembly as defined in claim 6, wherein said connecting part of said disconnecting mechanism drivingly engages said second casing and said clutch sleeve.

8. The torque coupling differential assembly as defined in claim 7, wherein said connecting part has internal splines and both said second casing and said clutch sleeve have external splines provided to be engaged with said internal splines of said connecting part when said disconnecting mechanism is in said connected position.

9. The torque coupling differential assembly as defined in claim 8, wherein said disconnecting mechanism includes a shifting collar positively coupled to said connecting part to move said connecting part between said disconnected and connected positions thereof.

10. The torque coupling differential assembly as defined in claim 8, wherein said disconnecting mechanism includes an actuator provided to selectively shift said connecting part of said disconnecting mechanism between said disconnected position and said connected position.

11. The torque coupling differential assembly as defined in claim 10, wherein said actuator is manually actuatable by an operator.

12. The torque coupling differential assembly as defined in claim 10, wherein said actuator is automatically actuatable by an electronic control unit.

13. The torque coupling differential assembly as defined in claim 1, wherein said disconnecting mechanism includes an actuator provided to selectively operate said disconnecting mechanism.

14. The torque coupling differential assembly as defined in claim 3, wherein said speed sensitive fluid pump assembly includes a gerotor pump.

15. The torque coupling differential assembly as defined in claim 2, wherein said first casing encapsulates at least a portion of said second casing.

16. The torque coupling differential assembly as defined in claim 2, wherein said second casing is coaxially arranged with respect to a rotational axis of said fist casing.

17. The torque coupling differential assembly as defined in claim 3, wherein said friction clutch assembly and said fluid pump assembly are coaxially arranged with respect to a rotational axis of said fist casing.

18. The torque coupling differential assembly as defined in claim 1, wherein said differential mechanism is a planetary differential assembly.

19. The torque coupling differential assembly as defined in claim 1, further includes a ring gear mounted to a flange formed on said first casing.

20. An all-wheel-drive vehicle comprising:
a prime mover;
a primary full-time drive axle assembly driven by said prime mover to drive one of front wheels and rear wheels;
an auxiliary drive axle assembly provided to drive the other one of said front wheels and said rear wheels;
a torque coupling differential assembly provided between said primary and auxiliary drive axle assemblies, said torque coupling differential assembly comprising:
a housing enclosing said torque coupling differential assembly and having a first casing defining an input member;
a differential mechanism;
a speed-sensitive torque coupling device including a friction clutch assembly and provided to transmit a drive torque from said first casing to said differential mechanism; and
a disconnecting mechanism selectively shiftable between a disconnected position when said differential mechanism is disconnected from said speed-sensitive torque coupling device and a connected position when said differential mechanism is drivingly engaged to said speed-sensitive torque coupling device so that said friction clutch assembly transmits torque from said first casing to said differential mechanism when said speed-sensitive torque coupling device is in an activated position and said disconnecting mechanism is in said connected position;
wherein both said speed-sensitive torque coupling device and said differential mechanism are disposed within said housing.
